(19) United States
(12) Patent Application Publication
(10) Pub. No.: US 2005/0259676 A1
(43) Pub. Date: Nov. 24, 2005

(54) Method and apparatus for forwarding multi-hop and MACdata structure for the method

(76) Inventor: Chan-soo Hwang, Yongin-city (KR)

Correspondence Address: LEE & STERBA, P. C., Suite 2000, 1101 Wilson Boulevard, Arlington, VA, 22209, US

(21) Appl. No.: 10/402,945

(22) Filed: Apr. 1, 2003

(30) Foreign Application Priority Data
Apr. 11, 2002 (KR) 2002-19722

(51) Int. Cl. H04J 4/00

(52) U.S. Cl. 370/436

(57) ABSTRACT

A method of forwarding a multi-hop data by which a multi-hop data frame having multi-hop information is processed, includes a mobile terminal for performing the method, and a medium access control (MAC) data structure having a multi-hop frame, which is used in the method. In the method, information is forwarded via one or more mobile terminals or a pre-installed seed to an access point, thereby allowing coverage of an access point to be extended. As a result, a communication system may be economically established, and waste of frequency resources may be reduced.

### BACKGROUND OF THE INVENTION

1. Field of the Invention

The present invention relates to a method of forwarding multi-hop data by which a multi-hop data frame having multi-hop information is processed, a mobile terminal for performing the method, and a medium access control (MAC) data structure having a multi-hop frame, which is used in the method.

2. Description of the Related Art

Multi-hop forwarding is a method by which information is forwarded through communication with one or more mobile terminals or a pre-installed seed terminal, as opposed to direct communication between an access point (AP) and a mobile terminal (MT).

FIG. 1 illustrates a view for explaining a method of forwarding a multi-hop. Referring to FIG. 1, a mobile terminal 1 (MT1) 101 is distant from an access point (AP) 102 or is otherwise incapable of communicating directly with the AP 102 because of deterioration of channel quality due to fading. Thus, the MT1 101 forwards information that needs to be forwarded to the AP 102 to a MT2 103 having the highest channel quality of MTs around MT1, and then the MT2 103 forwards the received information to the AP 102.

If other MTs to which a multi-hop is to be forwarded do not exist around the MT1 or they have poor channel quality and are incapable of forwarding the multi-hop, a seed 104 may be installed to forward the multi-hop.

Let us suppose that a MT4 105 is incapable of communicating directly with the AP 102 and a MT having high channel quality does not exist around MT4 105. In this case, the MT4 105 forwards information to the seed 104, and then the seed 104 forwards the information to the AP 102. Thus, although a MT is positioned beyond the coverage area of the AP 102, the MT is able to communicate with the AP 102. As a result, the coverage area of the AP 102 is extended.

In the prior art multi-hop forwarding method, since a specific time or a specific frequency is assigned to forward a multi-hop, it is possible to improve interference between a multi-hop transmission signal and a direct transmission signal.

However, when an additional new frequency is assigned, each MT requires an additional transmitter and receiver using the assigned frequency. Also, the use of an additional frequency wastes frequency resources. Further, when a specific time is assigned, another MT is prohibited from directly forwarding information to an AP, thereby decreasing the efficiency of the entire system.

As LANs are generalized, there are growing interests in wireless LANs that do not require re-installation of cables when office spaces or production facilities are rearranged. Wireless LANs enable the transmission and reception of various kinds of control information and database searches via mobile terminals, e.g., automatic guided vehicles in factories, hand-held computer terminals in stock exchanges, and the like.

In a wireless LAN, terminals may be easily rearranged, communications are possible even while terminals are being moved, and the network may be established quickly. However, transmission speeds may be slower and signal interference higher in a wireless LAN than in a wired LAN.

The Institute of Electrical and Electronics Engineers (IEEE) 802 Committee recognized the need for standardizing wireless LANs. Accordingly, the IEEE organized the IEEE 802.11 Committee in May, 1991, to begin the standardization of wireless LANS. A Draft Standard (DS) 3.0 was prepared in 1996, which eventually led to the establishment of the standard wireless LAN IEEE 802.11. Due to the standardization of wireless LANS, it is expected that the wireless LAN market will become more active based on securing of mutual operations between MTs, the development of related parts, and so on.

The standards of wireless LANs may be classified into the IEEE 802.11 and the HiperLAN standard established by the European Telecommunication Standards Institute (ETSI) RES10. The IEEE 802.11 has as its object wireless LANs that provide a maximum transmission speed of 2 Mbps in an Industrial/Scientific/Medical (ISM) frequency band, while the HiperLAN standard provides a maximum transmission speed of 15 Mbps in a 5.2 GHz band.

A HiperLAN2 network, an extension of the HiperLAN standard, is generally composed of many APs. A MT is connected to an AP having the best wireless link in the HiperLAN2 network. Here, the MT is able to move freely and be connected to another AP by a handover method when the performance of a wireless link deteriorates.

In view of an AP, a protocol model of HiperLAN2 includes a convergence layer, a data link control (DLC) layer, and a physical layer. Among these, the DLC layer is composed of a medium access control (MAC) sublayer, an error control sublayer, and a wireless link control sublayer.

Since a MAC frame of the HiperLAN2 uses a connectivity structure of time division multiplexing (TDM), as opposed to a nonconnectivity structure of Carrier Sense Multiple Access/Collision Avoidance (CSMA/CD) of the IEEE 802.11, the MAC frame provides Quality of Service (QoS) such as bandwidth, time delay, bit error rate (BER), and the like. Due to the QoS, various kinds of data such as images, voice, etc. may be transmitted at the same time. The MAC frame has a length, or period, of 2 msec and 6 channels.

FIG. 2 shows the structure of a MAC frame of the HiperLAN2. Referring to FIG. 2, a MAC frame 201 has a period of 2 msec and is composed of a Broadcast CHannel (BCH) 202, a Frame CHannel (FCH) 203, an Access feedback CHannel (ACH) 204, a Downlink 205, an Uplink 206, and a Random CHannel (RCH) 207.

The BCH 202 has 120 bits and stores Broadcast Control CHannel (BCCH) information. The BCCH is a logic channel that broadcasts control information corresponding to a current MAC frame.

When the FCH 203 is broadcast, Frame Control CHannel (FCCH) information is transmitted. The FCCH includes information that defines how system resources are assigned to the current MAC frame.

Results obtained during a random access of a previous MAC frame are transmitted to the ACH 204.

The Downlink 205 transmits data from an AP to a MT, while the Uplink 206 transmits data from the MT to the AP.

The RCH 207 allows the MT to transmit control information to the AP when the transmission of the control information via a Short transport CHannel (SCH) 209 is impossible.

The Downlink 205 and the Uplink 206 are composed of Long transport CHannels (LCHs) 208 and SCHs 209, respectively. Used data is transmitted to the LCH 208 and control information is transmitted to the SCH 209.

FIG. 3 shows the structure of a MAC frame of the HiperLAN2 having N sectored antennas. Here, the basic structure of the MAC frame is similar to that of the MAC frame of FIG. 2. However, since the MAC frame has N sectors, a Broadcast CHannel 1 (BCH₁) 301 through a BCHN 302, a Frame CHannel 1 (FCH₁) 303, an Access feedback CHannel 1 (ACH₁) 304 through an Access feedback CHannel N ACHN, a Downlink 1 (Down₁) 310 through a Downlink N (DownN) 311, an Uplink 1 (Up₁) 320 through an Uplink N (UPN) 321, and a Random CHannel 1 (RCH₁) 330 through a RCHN 331 are arranged in the order of the sectors. The functions of the channels are the same as described with reference to FIG. 2.

FIG. 4 shows a transmission signal string in each of the sectors having N sectored antennas of the MAC frame of the HiperLAN2 of FIG. 3.

As shown in FIGS. 3 and 4, channels respectively corresponding to sectors are assigned to antennas. When other sectors use the channels, signals are not transmitted to the other sectors. Thus, sectoring may be performed with only one transmitter, which is included in an AP. However, since the other sectors do not operate, frequency efficiency is reduced.

FIG. 5 shows the structure of a conventional MAC frame for forwarding a multi-hop. As shown in FIG. 5, multi-hop forwarding is performed during processing a multi-hop (MH) 502 right before an Uplink 501 starts.

The MH 502 includes a Forward-Broadcast CHannel (F-BC) having a Forward-Broadcast CHannel (F-BCH) 503, a Forward-Frame CHannel (F-FCH) 504, and a Forward-Access feedback CHannel (F-ACH) 505, a Forward-Downlink (F-DL) 510, a Forward-Uplink (F-UL) 511, and a Forward-Random CHannel (F-RCH) 512. The F-BCH 503 broadcasts all MAC frame information about terminals capable of seeding or seeds. The F-FCH 504 forwards MAC frame information storing reserved data about terminals capable of seeding or seeds. The results of attempts to access a MAC frame are forwarded to the F-ACH 505. Then the F-RCH 512 forwards control information to a terminal, which may be used as a seed by a MT or a seed.

Since the time required for communication between different terminals or a terminal and a seed is different from the time required for the transmission and reception of data between an AP and a terminal, interference between a directly transmitted signal and a multi-hop forwarding signal may be removed. However, transmission efficiency decreases by the time required for forwarding the multi-hop. Thus, a multi-hop forwarding method capable of solving this problem is required.

### SUMMARY OF THE INVENTION

In an effort to solve the above-described problems, it is a feature of an embodiment of the present invention to provide an apparatus and a method for forwarding a multi-hop capable of processing a multi-hop data frame having information on the multi-hop, and a medium access control data structure, having a multi-hop frame, which is used in the method.

To provide a feature of an embodiment of the present invention, a method of forwarding a multi-hop in a system having an access point, a first mobile terminal that is incapable of communicating directly with the access point, and a second mobile terminal that is capable of communicating directly with the access point, is provided, the method including (a) transmitting data of the first mobile terminal to the second mobile terminal while the access point is transmitting or receiving data to or from a mobile terminal located in a sector beyond a sector to which the second mobile terminal belongs, (b) the second mobile terminal transmitting data of the first mobile terminal to the access point by an existing transmission and reception method, and (c) the access point receiving the data of the first mobile terminal.

The second mobile terminal may be a seed that transmits data of a mobile terminal that is incapable of communicating directly with the access point to the access point.

In the method, the second mobile terminal may (a) set up a channel for communication with the first mobile terminal, (b) determine whether the access point is transmitting data to or receiving data from a mobile terminal located in a sector beyond the sector to which the second mobile terminal belongs, and (c) receive data of the first mobile terminal if it is determined that the access point is transmitting or receiving data to or from the mobile terminal located in the sector beyond the sector to which the second mobile terminal belongs.

In another embodiment of the present invention, a method of forwarding a multi-hop is provided in a system having an access point, a first mobile terminal that is incapable of communicating directly with the access point, and a second mobile terminal that is capable of communicating directly with the access point, the method including (a) the access point transmitting data of the first mobile terminal to the second mobile terminal by an existing transmission and reception method, (b) the second mobile terminal transmitting data to the first mobile terminal while the access point is transmitting or receiving data to or from a mobile terminal located in a sector beyond a sector to which the second mobile terminal belongs, and (c) the first mobile terminal receiving the data transmitted in (b).

In another embodiment of the present invention, a computer-readable recording medium is provided on which a computer program for executing the methods described above is recorded.

To provide another feature of an embodiment of the present invention, a mobile terminal for forwarding a multi-hop is provided, the mobile terminal including a communication channel setter which sets up a channel for communication with a first mobile terminal that is incapable of communicating directly with an access point, a state determiner which determines whether the access point is transmitting or receiving data to or from a mobile terminal located in a sector beyond a sector to which a second mobile terminal belongs, and a multi-hop data transmitter which transmits and receives data of the first mobile terminal to and from the second mobile terminal if it is determined that the access point is transmitting or receiving data to or from the mobile terminal located in the sector beyond the sector to which the second mobile sector belongs.

To provide another feature of an embodiment of the present invention, a computer-readable recording medium on which a medium access control data structure is recorded is provided, the medium access control data structure being used when a mobile terminal that is incapable of communicating directly with an access point communicates with the access point via another mobile terminal, the medium access control data structure including a broadcast channel information value which broadcasts control information corresponding to a current medium access control frame, a frame channel information value which stores frame control channel information that defines how resources of a system are assigned to a current medium access frame, an access feedback channel information value which stores results obtained when a previous medium access control frame is randomly accessed, a down-data value which is transmitted from an access point to a mobile terminal; a first multi-hop data value which is transmitted from a mobile terminal that is incapable of communicating directly with the access point, an up-data value which is transmitted from a mobile terminal to the access point, a second multi-hop data value which is transmitted from the mobile terminal that is incapable of communicating directly with the access point, and a random channel value through which a mobile terminal transmits control information to the access point when a short transport channel is unavailable.

In the computer-readable recording medium, the first and second multi-hop data values may respectively include a forward-broadcast control channel information value which broadcasts control information corresponding to a current medium access control frame, a forward-downlink channel information value which receives data from the access point and forwards the data to a mobile terminal, a forward-uplink channel information value which receives data from the mobile terminal and forwards the data to the access point and a forward-random channel information value through which the mobile terminal forwards the control information to the access point.

In the computer-readable recording medium, the forward-broadcast control channel information value preferably includes a broadcast channel information value which broadcasts all medium access control frame information about sectors, a frame channel information value which forwards medium access control frame information representing reserved data about the sectors, and an access feedback channel information value to which results of attempts to access a medium access control frame are forwarded.

### BRIEF DESCRIPTION OF THE DRAWINGS

The above features and advantages of the present invention will become more apparent to those of ordinary skill in the art by describing in detail preferred embodiments thereof with reference to the attached drawings in which:

FIG. 1 illustrates a view for explaining a conventional method of forwarding a multi-hop;

FIG. 2 illustrates a view of the structure of a conventional medium access control (MAC) frame of HiperLAN2;

FIG. 3 illustrates a view of the structure of a HiperLAN2 MAC frame having N sectored antennas;

FIG. 4 illustrates a view of a transmission signal string in each of the sectors having N sectored antennas of the MAC frame of the HiperLAN2 of FIG. 3;

FIG. 5 illustrates a view of the structure of a conventional MAC frame for forwarding a multi-hop;

FIG. 6 illustrates a view of a structure of a network for forwarding a multi-hop according to an embodiment of the present invention;

FIG. 7A is a flowchart for explaining a method by which an access point (AP) receives multi-hop data in a multi-hop forwarding network according to an embodiment of the present invention;

FIG. 7B is a flowchart for explaining a method by which an access point (AP) transmits multi-hop data in a multi-hop forwarding network according to an embodiment of the present invention;

FIG. 8 is a flowchart for explaining a method by which a mobile terminal (MT) that is incapable of communicating directly with an access point (AP) forwards data to the AP according to an embodiment of the present invention;

FIG. 9 is a flowchart for explaining a method by which a mobile terminal (MT) seeds data of the MT of FIG. 8;

FIG. 10 is a flowchart for explaining a method by which an access point (AP) processes multi-hop data according to an embodiment of the present invention;

FIG. 11 illustrates a view of a transmission signal string in each sector of a plurality of sectors of a medium access control data structure according to an embodiment of the present invention;

FIG. 12 is a block diagram of a mobile terminal (MT) that is incapable of communicating directly with an access point (AP) when forwarding data to the AP according to an embodiment of the present invention;

FIG. 13 is a block diagram of a mobile terminal (MT) that forwards data of a MT that is incapable of communicating directly with an access point (AP) to the AP according to an embodiment of the present invention;

FIG. 14 is a block diagram of an access point (AP) that processes multi-hop data according to an embodiment of the present invention;

FIG. 15 is a graph showing an improved communication range obtained by using a method of forwarding multi-hop according to an embodiment of the present invention with respect to a number of users;

FIG. 16 is a graph showing changes in the improved communication range when a path loss exponent changes and a number of users is fixed at 12;

FIG. 17 is a graph showing a communication range rate while using and not using multi-hop when a path loss exponent changes, while a number of users is fixed at 12;

FIG. 18 is a graph showing an improved communication range according to a number of users when only one seed is used to perform the multi-hop forwarding method according to the present invention;

FIG. 19 is a graph showing changes in a communication range when only one seed is used and a path loss exponent changes, while a number of users is fixed at 12; and

FIG. 20 is a graph showing communication range rates obtained while using and not using multi-hop, when only one seed is used and a path loss exponent changes, while a number of users is fixed at 12.

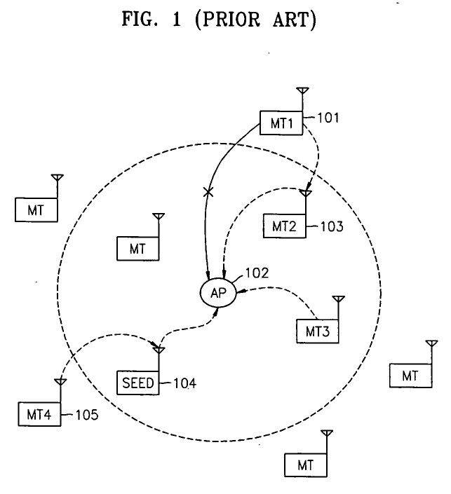

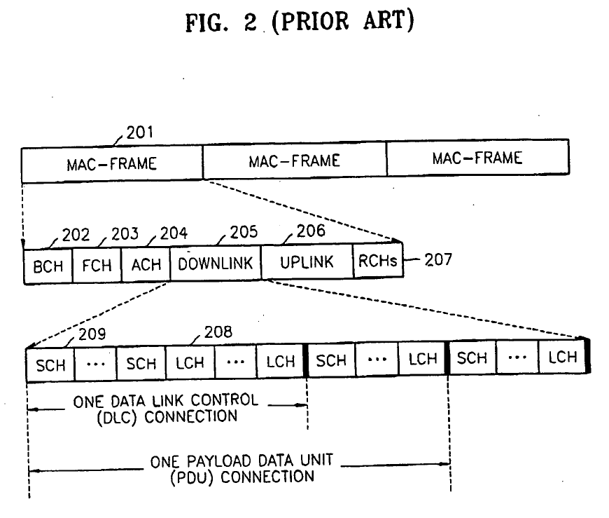

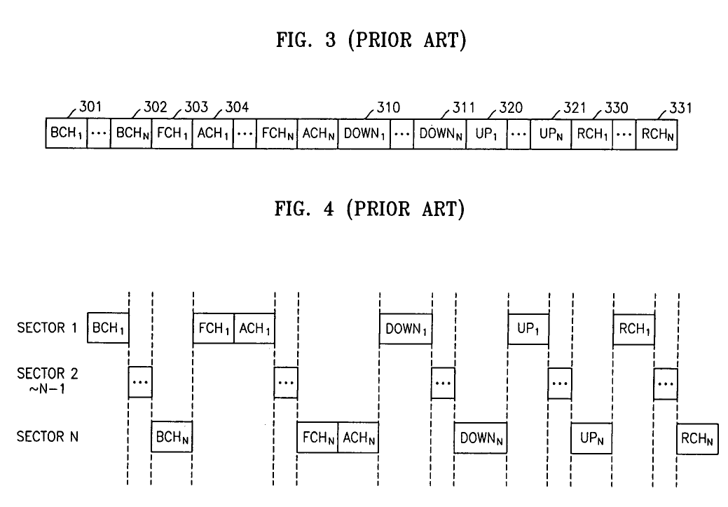

### DETAILED DESCRIPTION OF THE INVENTION

Korean Patent Application No. 2002-19722 filed on Apr. 11, 2002, and entitled: “Method And Apparatus For Forwarding Multi-Hop And Mac Data Structure For The Method” is incorporated by reference herein in its entirety.

The present invention will now be described more fully hereinafter with reference to the accompanying drawings, in which preferred embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art.

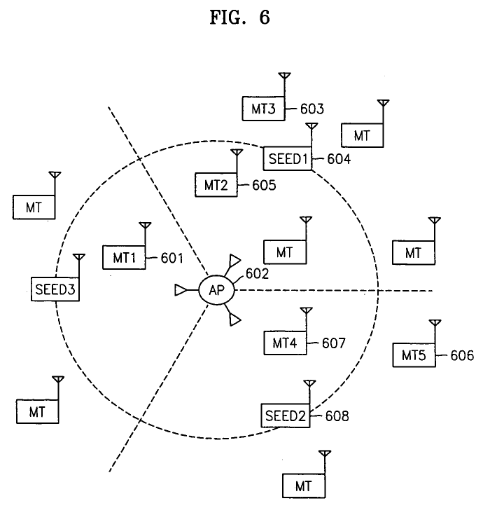

FIG. 6 shows the structure of a network for forwarding a multi-hop according to an embodiment of the present invention. Referring to FIG. 6, when a mobile terminal 1 (MT1) 601 communicates with an access point (AP) 602, a MT3 603 forwards information to a seed1 604 or a MT2 605. Here, a MT5 606 may also forward information to a MT4 607 or a seed2 608. The MT2 605 or the MT4 607 transmits information received from the MT3 603 or the MT5 606 to the AP 602.

Although the MT3 603 or the MT5 606 uses the seed1 604 or the seed2 608, the above-described process is performed.

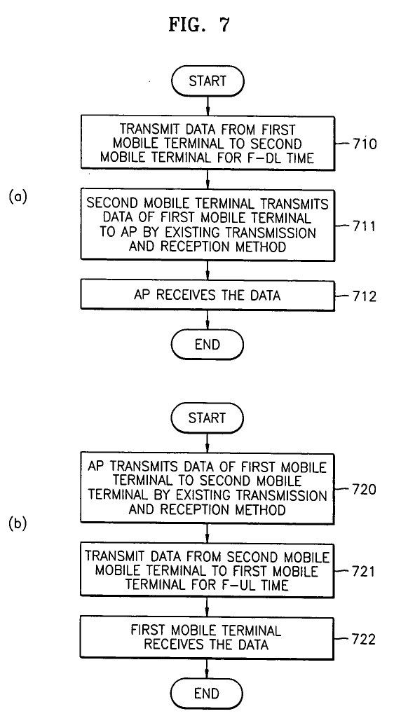

FIG. 7A is a flowchart for explaining a method of an embodiment of the present invention by which an access point (AP) receives multi-hop data in a multi-hop forwarding network.

The multi-hop forwarding network includes mobile terminals (MTs) and seeds that are capable of communicating directly with an AP, while MTs and seeds that are incapable of communicating directly with the AP are positioned outside the multi-hop forwarding network.

The MTs or seeds that are incapable of communicating directly with the AP transmit data to the MTs or seeds having the capability to communicate directly with the AP.

The MTs or seeds that are capable of communicating directly with the AP transmit the data to the AP. However, since the AP does not always communicate with a MT in its sector, a time delay required for the communication of the AP with a MT in another sector occurs.

In step 710, a first MT or seed that is incapable of communicating directly with an AP transmits multi-hop data to a second MT or seed having the capability to communicate directly with the AP within a period of time F-DL (a Forward-Downlink time) required for the AP to communicate with a MT located in a sector other than a sector to which the second MT belongs. In step 711, the second MT or seed, which receives the multi-hop data, transmits the multi-hop data to the AP and receives the multi-hop data from the AP by an existing transmission and reception method.

In step 712, the AP processes the received multi-hop data.

FIG. 7B is a flowchart for explaining a method of an embodiment of the present invention by which an access point (AP) transmits multi-hop data in a multi-hop forwarding network.

In step 720, an AP transmits data of a first MT that is incapable of communicating directly with the AP to a second MT having the capability to communicate directly with the AP by an existing transmission and reception method.

In step 721, the data is transmitted from the second MT to the first MT that is incapable of communicating directly with the AP within a period of time F-UL (a Forward-Uplink time) required for the AP to transmit data to or receive data from a MT located in a sector beyond a sector to which the second mobile terminal belongs.

In step 722, the first MT that is incapable of communicating directly with the AP receives the data transmitted in step 721.

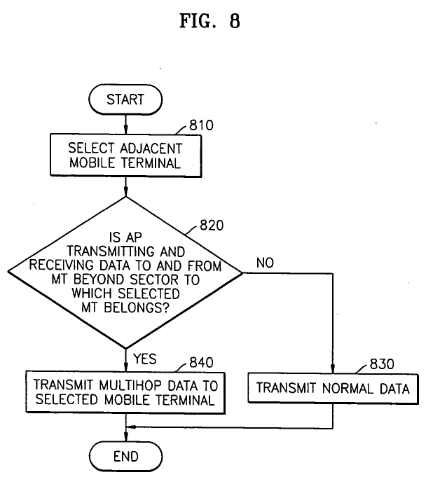

FIG. 8 is a flowchart for explaining a method of an embodiment of the present invention by which a mobile terminal (MT) that is incapable of communicating directly with an access point (AP) transmits data to the AP.

In step 810, an adjacent MT capable of communicating directly with the AP is selected.

In step 820, it is determined whether the AP is transmitting data to or receiving data from a MT located in a sector beyond a sector to which the selected MT belongs.

If it is determined that the AP is transmitting data to or receiving data from a MT located in a sector beyond the sector to which the selected MT belongs, in step 840, multi-hop data is transmitted to the selected MT. If not, that is, if the selected MT is transmitting or receiving its own data to or from the AP, in step 830, the transmission of normal data is performed.

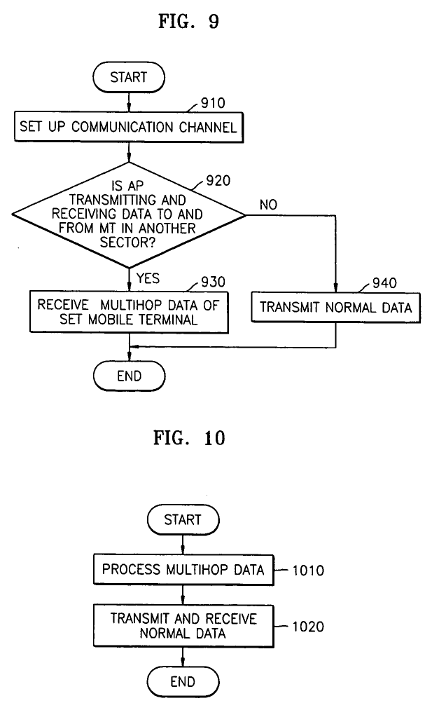

FIG. 9 is a flowchart for explaining a method of an embodiment of the present invention by which a mobile terminal (MT) seeds data from a MT that is incapable of communicating directly with an access point (AP).

In step 910, a channel is set up for communication with a first MT that is located in a sector beyond a sector in which direct communication with the AP is possible. Therefore, the first mobile terminal is incapable of communicating directly with the AP.

In step 920, it is determined whether the AP is transmitting data to or receiving data from another MT located in a sector beyond a sector to which the first MT belongs. As previously described, when the AP transmits data to or receives data from MTs located in other sectors, step 920 is performed to use the time required for the transmission and reception of data between the AP and the MTs located in other sectors.

If it is determined that the AP is transmitting data to or receiving data from another MT located in a sector beyond the sector to which the first MT belongs, in step 930, the first MT receives data of an adjacent MT that is incapable of communicating directly with the AP. If not, that is, if a MT is transmitting or receiving its own data to or from the AP, in step 940, the transmission of normal data is performed.

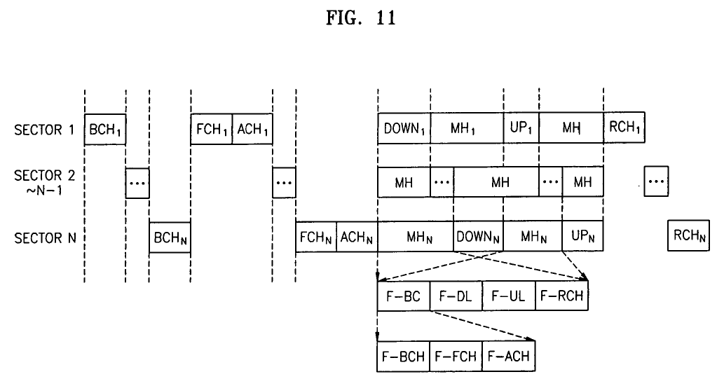

FIG. 10 is a flowchart for explaining a method by which an access point (AP) processes multi-hop data.

If an AP is transmitting data to or receiving data from an adjacent MT that is incapable of communicating directly with the AP, in step 1010, the AP receives the data of the adjacent MT via a MT having the capability to communicate directly with the AP. If not, in step 1020, the AP transmits normal data to or receives normal data from a MT located in a sector with which the AP is communicating.

FIG. 11 shows a transmission signal string in each sector of a plurality of sectors of a medium access control data structure according to an embodiment of the present invention. The basic structure of the transmission signal string of FIG. 11 is similar to that of FIG. 4, except that multi-hop frames for forwarding multi-hop data are assigned to sectors with which an AP does not communicate. When the multi-hop frames are not sequential, and resources for communicating with the AP are assigned to a given sector, common downlink or uplink communication is performed, and then the process returns to the original multi-hop frames.

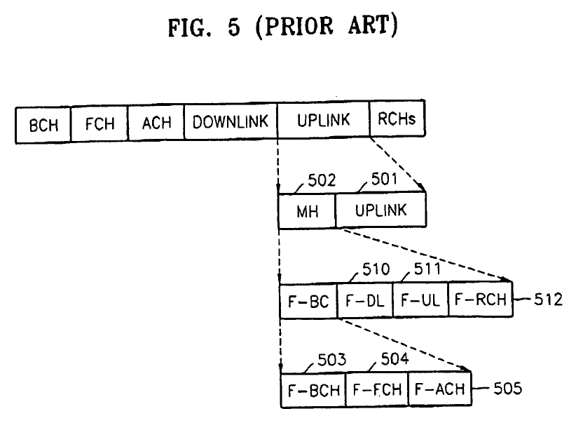

In order to apply the above-described method to the HiperLAN2, the multi-hop frame structure of FIG. 5 is used. A multi-hop forwarding frame is composed of a Broadcast control CHannel having a Forward-Broadcast CHannel (F-BCH) 503 which broadcasts all MAC frame information about sectors, a Forward-Frame CHannel (F-FCH) 504 which forwards MAC frame information storing reserved data about the sectors, a Forward-Access feedback CHannel (F-ACH) 505 to which the results of attempts to access a MAC frame are forwarded, a Forward-Downlink 510, a Forward-Uplink 511, and a Forward-Random CHannel (F-RCH) 512 through which an MT forwards control information to an AP.

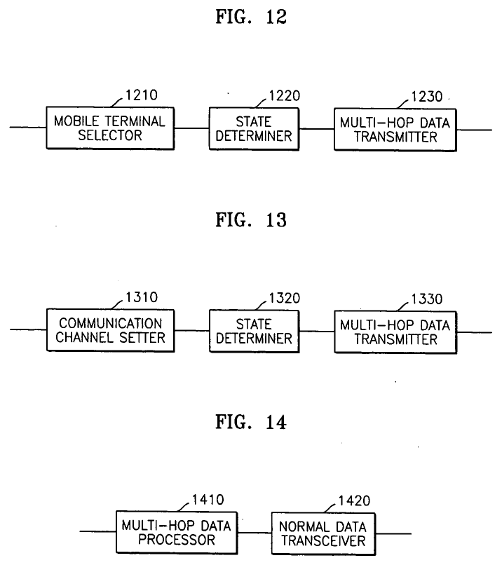

FIG. 12 is a block diagram of a mobile terminal (MT) that is incapable of communicating directly with an access point (AP) when forwarding data to the AP. Referring to FIG. 12, a MT selector 1210 selects an adjacent MT that is capable of communicating directly with the AP.

A state determiner 1220 determines whether the AP is transmitting data to or receiving data from a MT located in a sector beyond a sector to which the selected MT belongs.

A multi-hop data transmitter 1230 transmits and receives the multi-hop data within a period of time that the AP transmits data to or receives data from the MT located in the sector beyond the sector to which the selected MT belongs, based on the results determined by the state determiner 1220. Thus, the MT that is incapable of communicating directly with the AP communicates with the AP.

FIG. 13 is a block diagram of a mobile terminal (MT) that forwards data of a MT that is incapable of communicating directly with an access point (AP) to the AP according to the present invention.

A communication channel setter 1310 sets up a channel for communication with a first MT that is incapable of communicating directly with the AP.

A state determiner 1320 determines whether the AP is transmitting data to or receiving data from a MT located in a sector beyond a sector to which a second MT belongs.

A multi-hop data transmitter 1330 transmits and receives data of the first mobile terminal to and from the second MT if it is determined that the AP is transmitting data to or receiving data from the MT located in a sector beyond the sector to which the second MT belongs.

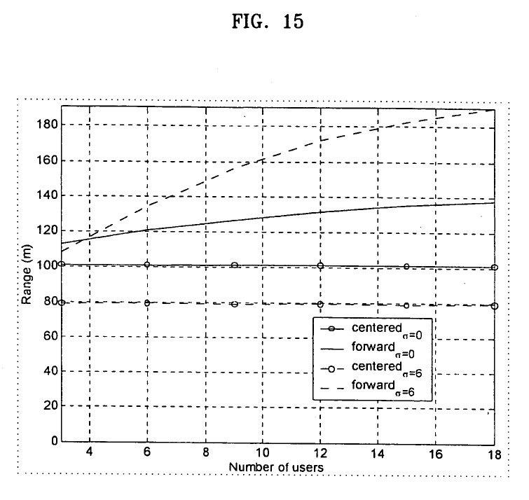

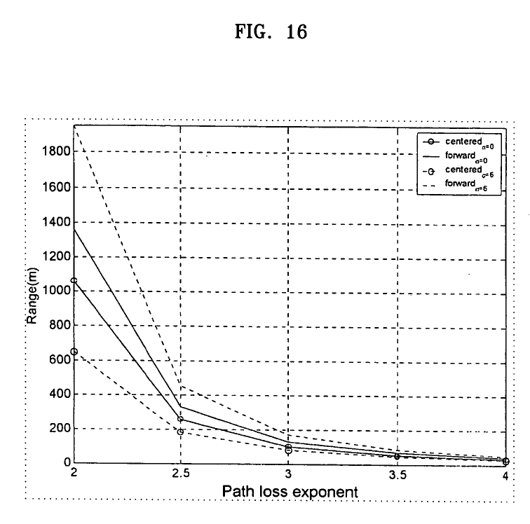

FIG. 14 is a block diagram of an access point (AP) that processes multi-hop data.

If an AP is transmitting data to or receiving data from a mobile terminal (MT) located in a sector beyond a sector in which direct communication with the AP is possible, a multi-hop data processor 1410 receives data of an adjacent MT that is incapable of communicating directly with the AP via a MT that is capable of communicating directly with the AP.

If not, a normal data transceiver 1420 transmits normal data to or receives normal data from a MT located in a sector with which the AP is communicating.

FIGS. 15 through 20 are graphs showing an improved communication range obtained by using the multi-hop forwarding method according to the present invention. The conditions to perform the multi-hop forwarding method are as follows. First, it is assumed that channels are a log distance model and a lognormal fading model. Here, the path loss is given by equation 1.
Path loss=46.76+α10 log(d)+Fading (1)

where “d” is a distance in meters between a transmitter and a receiver and “α” is a path loss exponent.

A target outage probability is 10% and signal-to-noise ratio (SNR) is 10⁻⁷ bit error rate (BER). A transmitting and receiving cell displays a uniform distribution and the number of users displays a Poisson distribution.

FIG. 15 shows the improved communication range obtained by using the multi-hop forwarding method of the present invention with respect to the number of users. Here, it is assumed that the path loss exponent “α” is 3.

In FIGS. 15 and 16, the solid and dashed lines having the symbols ‘∘’ thereon and labelled as “centered” in the legend represent a communication range obtained when multi-hop is not provided, and the solid and dashed lines having no symbols thereon and labelled as “forward” in the legend represent the improved communication range obtained when the multi-hop forwarding method of the present invention is provided. Also in FIGS. 15 and 16, the solid lines represent communication ranges obtained with no lognormal fading, whereas the dashed lines represent communication ranges obtained when lognormal fading exists.

As illustrated by the lines labelled “centered” in FIG. 15, if multi-hop is not provided, the communication range does not vary with the average number of users. However, as illustrated by the lines labelled “forward” in FIG. 15, if multi-hop is provided, a gain may be obtained. In particular, if lognormal fading exists, as illustrated by the dashed “forward” line in FIG. 15, the communication range may double due to a diversity effect on the lognormal fading.

FIG. 16 shows changes in the improved communication range when a path loss exponent changes and when the number of users is fixed at 12.

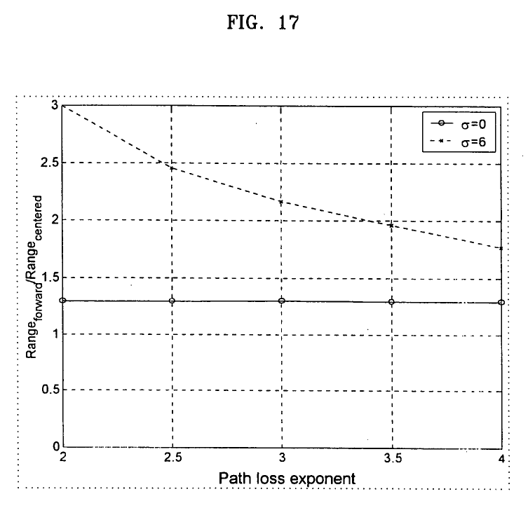

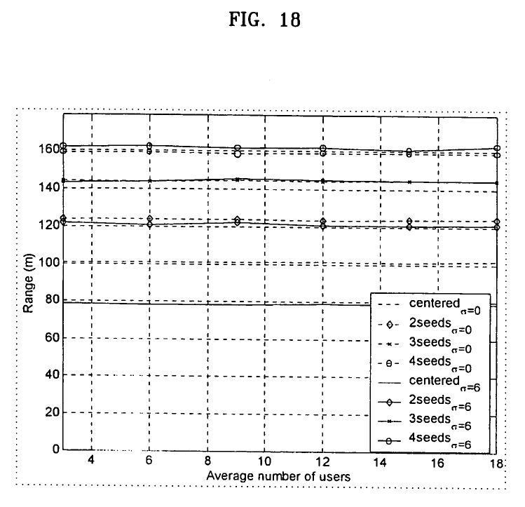

FIG. 17 shows communication range rates while using and not using multi-hop when a path loss exponent changes and when the number of users is fixed at 12.

As illustrated in FIGS. 16 and 17, when lognormal fading is great, the communication range may increase by as much as 300%. Also, FIGS. 16 and 17 indicate that the communication range is inversely proportional to the path loss exponent α.

FIGS. 18 through 20 show results obtained under conditions similar to those in FIGS. 15 through 17 except that a MT is not able to support multi-hop and either one, two, three or four seeds are used.

FIG. 18 shows the improved communication range obtained by using the multi-hop forwarding method of the present invention with respect to the number of users for cases when one, two, three and four seeds are used.

FIG. 18 indicates that the communication range increases as the number of seeds increases regardless of the number of users.

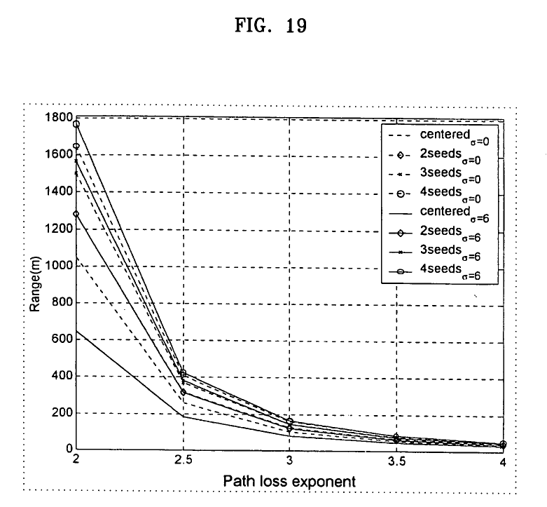

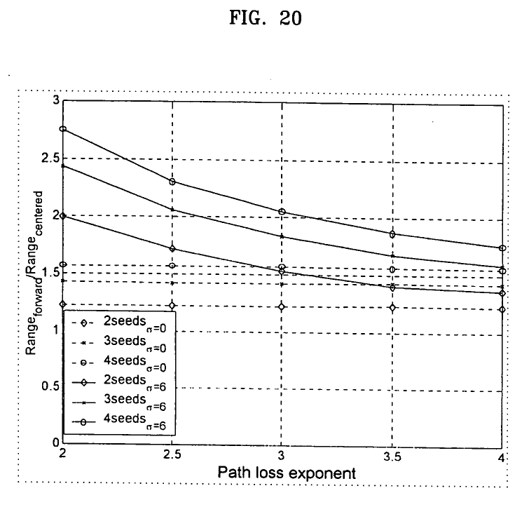

FIG. 19 shows changes in the communication range for cases when one, two, three and four seeds are used and a path loss exponent changes while the number of users is fixed at 12.

FIG. 20 shows communication range rates while using and not using multi-hop for cases when one, two, three and four seeds are used and a path loss exponent changes while a number of users is fixed at 12.

As illustrated in FIGS. 18-20, the improved communication range is not greater than a case when all of the MTs support multi-hop, as illustrated in FIGS. 15-17. However, when the number of seeds is about 4, the improved communication range illustrated in FIGS. 18-20, when a MT does not support multi-hop, is similar to a case when all of the MTs support multi-hop, as shown in FIGS. 15-17.

As described above, sectors of a plurality of sectors capable of communicating with an access point (AP) transmit data to the AP through downlink and uplink, and, at the same time, sectors that are not capable of communicating with the AP process multi-hop data frames having multi-hop information. Thus, coverage of an AP is extended allowing a communication system to be economically established while reducing waste of frequency resources.

The above-described embodiments of the present invention may be written in computer programs and may be realized in general-purpose computers using computer-readable recording media.

Also, data structures used in the embodiments of the present invention may be recorded on computer-readable recording media through many means.

The computer-readable recording media include storing media, such as magnetic storing media (e.g., ROMs, floppy discs, hard discs, etc.), optical reading media (e.g., CD-ROMs, DVDs, etc.), and carrier waves (e.g., transmissions via the Internet).

Preferred embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

1. A method of forwarding a multi-hop in a system having an access point, a first mobile terminal that is incapable of communicating directly with the access point, and a second mobile terminal that is capable of communicating directly with the access point, the method comprising:
(a) transmitting data of the first mobile terminal to the second mobile terminal while the access point is transmitting or receiving data to or from a mobile terminal located in a sector beyond a sector to which the second mobile terminal belongs;
(b) the second mobile terminal transmitting data of the first mobile terminal to the access point by an existing transmission and reception method; and
(c) the access point receiving the data of the first mobile terminal.

2. The method as claimed in claim 1, wherein the second mobile terminal is a seed that transmits data of a mobile terminal that is incapable of communicating directly with the access point to the access point.

3. The method as claimed in claim 1, wherein the second mobile terminal:
(a) sets up a channel for communication with the first mobile terminal,
(b) determines whether the access point is transmitting data to or receiving data from a mobile terminal located in a sector beyond the sector to which the second mobile terminal belongs; and
(c) receives data of the first mobile terminal if it is determined that the access point is transmitting or receiving data to or from the mobile terminal located in the sector beyond the sector to which the second mobile terminal belongs.

4. A method of forwarding a multi-hop in a system having an access point, a first mobile terminal that is incapable of communicating directly with the access point, and a second mobile terminal that is capable of communicating directly with the access point, the method comprising:
(a) the access point transmitting data of the first mobile terminal to the second mobile terminal by an existing transmission and reception method;
(b) the second mobile terminal transmitting data to the first mobile terminal while the access point is transmitting or receiving data to or from a mobile terminal located in a sector beyond a sector to which the second mobile terminal belongs; and
(c) the first mobile terminal receiving the data transmitted in (b).

5. A computer-readable recording medium on which a computer program for executing the method claimed in claim 1 is recorded.

6. A mobile terminal for forwarding a multi-hop, the mobile terminal comprising:
a communication channel setter which sets up a channel for communication with a first mobile terminal that is incapable of communicating directly with an access point;
a state determiner which determines whether the access point is transmitting or receiving data to or from a mobile terminal located in a sector beyond a sector to which a second mobile terminal belongs; and
a multi-hop data transmitter which transmits and receives data of the first mobile terminal to and from the second mobile terminal if it is determined that the access point is transmitting or receiving data to or from the mobile terminal located in the sector beyond the sector to which the second mobile sector belongs.

7. A computer-readable recording medium on which a medium access control data structure is recorded, the medium access control data structure being used when a mobile terminal that is incapable of communicating directly with an access point communicates with the access point via another mobile terminal, the medium access control data structure comprising:
a broadcast channel information value which broadcasts control information corresponding to a current medium access control frame;
a frame channel information value which stores frame control channel information that defines how resources of a system are assigned to a current medium access frame;
an access feedback channel information value which stores results obtained when a previous medium access control frame is randomly accessed;
a down-data value which is transmitted from an access point to a mobile terminal;
a first multi-hop data value which is transmitted from a mobile terminal that is incapable of communicating directly with the access point;
an up-data value which is transmitted from a mobile terminal to the access point;
a second multi-hop data value which is transmitted from the mobile terminal that is incapable of communicating directly with the access point; and
a random channel value through which a mobile terminal transmits control information to the access point when a short transport channel is unavailable.

8. The computer-readable recording medium as claimed in claim 7, wherein the first and second multi-hop data values respectively comprise:
a forward-broadcast control channel information value which broadcasts control information corresponding to a current medium access control frame;
a forward-downlink channel information value which receives data from the access point and forwards the data to a mobile terminal;
a forward-uplink channel information value which receives data from the mobile terminal and forwards the data to the access point; and
a forward-random channel information value through which the mobile terminal forwards the control information to the access point.

9. The computer-readable recording medium as claimed in claim 8, wherein the forward-broadcast control channel information value comprises:
a broadcast channel information value which broadcasts all medium access control frame information about sectors;
a frame channel information value which forwards medium access control frame information representing reserved data about the sectors; and
an access feedback channel information value to which results of attempts to access a medium access control frame are forwarded.
